(19) United States
(12) Patent Application Publication
(10) Pub. No.: US 2004/0007310 A1
(43) Pub. Date: Jan. 15, 2004

(54) Automatic shaping method for production of hive-like venetian blinds

(75) Inventor: Pey-Son Hsu, Changhua Hsien (TW)

Correspondence Address: TROXELL LAW OFFICE PLLC, 5205 LEESBURG PIKE, SUITE1404, FALLS CHURCH, VA, 22041, US

(73) Assignee: CHING FENG BLINDS IND. CO., LTD

(21) Appl. No.: 10/190,571

(22) Filed: Jul. 9, 2002

(51) Int. Cl. B32B 3/00

(52) U.S. Cl. 156/70; 156/197; 156/73.1

(57) ABSTRACT

An automatic shaping method for production of hive-like Venetian blinds being preset in width and full length, draping length (or folds thereof) beforehand via an electric equipment is consisted of several operation steps. First, half-produced hive-like slats of said blind are formed in the first sealing step of high frequency welding after two roller fabrics of the same width sent out separately via roller shafts are met at a material-feeding wheel, and then sealed at both corresponding edges thereof and printed with decoration patterns thereon via an ultrasonic wave device. Second, the step of glue-applying, said half-produced hive-like slats are applied with thermal molten glue at the bottom side thereof according to the pre-set draping length thereof before an automatic detection unit censors out the defectives for a cutting device to exclude the defectives thereof and divide said half-produced hive-like slats at a pre-set length. Third, each piece of said cut half-produced hive-like slats, sent into a guide groove of a housing unit, is pressed downwards via an automatic pressing board to be piled on top of the prior hive-like slat sent in before and stuck thereto via said thermal molten glue to form a hive-like blind. After being laminated into the present draping length or folds thereof, said hive-like slats are sent out from the bottom side of said housing unit to obtain a hive-like Venetian blind with decoration patterns disposed at both lateral edges thereon.

### BACKGROUND OF THE INVENTION

The present invention is related to an automatic shaping method for production of hive-like Venetian blinds, consisting of three major steps of production. The first is the sealing step wherein two separate roller fabrics of the same width are fastened at both corresponding lateral sides thereof and printed with decoration patterns thereon via an ultrasonic wave device to form half-produced hive-like slats. In the second step of glue-applying, said half-produced hive-like slats are applied with thermal molten glue at the bottom side thereof and separated into a certain length via a cutting device before sent into a guide groove of a housing unit for the final step of fastening and laminating in which pieces of said cut hive-like slats are piled up to pre-set folds and stuck together via said thermal molten glue to form a hive-like Venetian blind.

Please refer to FIG. 1. A conventional method of producing a hive-like Venetian blind usually comprises the following steps:

First, a fabric 1 of proper width is fed into a roller 11 with both lateral edges of said fabric 1 folded up inwards to the middle section thereof and then roller pressed into folding lines thereon via a rolling shaft 12.

Second, said folding edges thereof are fastened together via a glue-applying device 13.

Third, after a detection device 14 censoring and excluding the defectives, the half-produced blind slat is cut into a pre-set length via a cutting device 15.

Forth, the half-produced blind slat cut into a pre-set length is applied with fastening agent at the bottom middle section thereof via a glue-applying means 17 and sent into a guide groove 181 of a housing unit 18 via a material feeding wheel 16.

Fifth, a pressing board 182 will push downwards each piece of said half-produced blind slat 1, piling on top of the prior one and fastened thereto via said fastening agent thereof. Said half-produced blind slats 1 are piled up and fastened to pre-set folds to obtain a hive-like Venetian blind.

There are several drawbacks to such conventional method of producing hive-like Venetian blinds. First, said fabric of proper width is folded at both lateral edges and roller pressed to produce folding lines which in the process of roller pressing might be easily deformed, increasing the cases of the defectives. Second, when in practical use, both lateral edges 10 fastened by said glue-applying device 8 might easily come off from both lateral sides thereof as shown in FIG. 2. Third, when said folding edges thereof are produced via said roller 11, it is impossible to produce decoration patterns thereon at the same time.

### SUMMARY OF THE PRESENT INVENTION

It is, therefore, the primary purpose of the present invention to provide an automatic shaping method for production of hive-like Venetian blinds wherein two roller fabrics of the same width are fed in separately via two roller shafts and sealed up at both corresponding lateral sides thereof via an ultrasonic wave device to form half-produced hive-like slats for the following steps of glue-applying, and fastening and laminating to produce a hive-like Venetian blind, greatly simplifying and reducing the production steps thereof.

It is, therefore, the second purpose of the present invention to provide an automatic shaping method for production of hive-like Venetian blinds wherein said roller fabrics are met at a material feeding wheel and fastened at both corresponding lateral edges thereof via said ultrasonic wave device, preventing the deformation of said lateral edges thereof and thus the result of the defectives thereof.

### BRIEF DESCRIPTION OF THE DRAWINGS

FIG. 1 is a diagram showing the process of a conventional shaping method of a hive-like Venetian blind.

FIG. 2 is a sectional view showing the coming-off of said conventional hive-like blind.

FIG. 3 is a diagram showing the production process of the present invention.

FIG. 3-A is a partially sectional view of the produced hive-like blind of the present invention.

FIG. 4 is a diagram showing the collection of the blinds in a housing unit.

FIG. 5 is a block flow chart of the present invention.

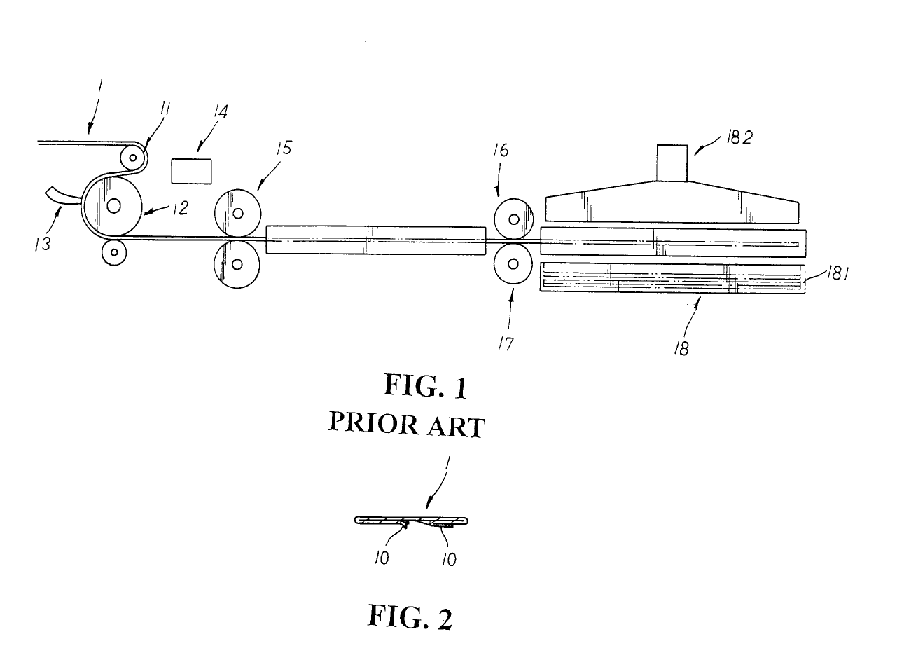

### DETAILED DESCRIPTION OF THE PREFERRED EMBODIMENTS

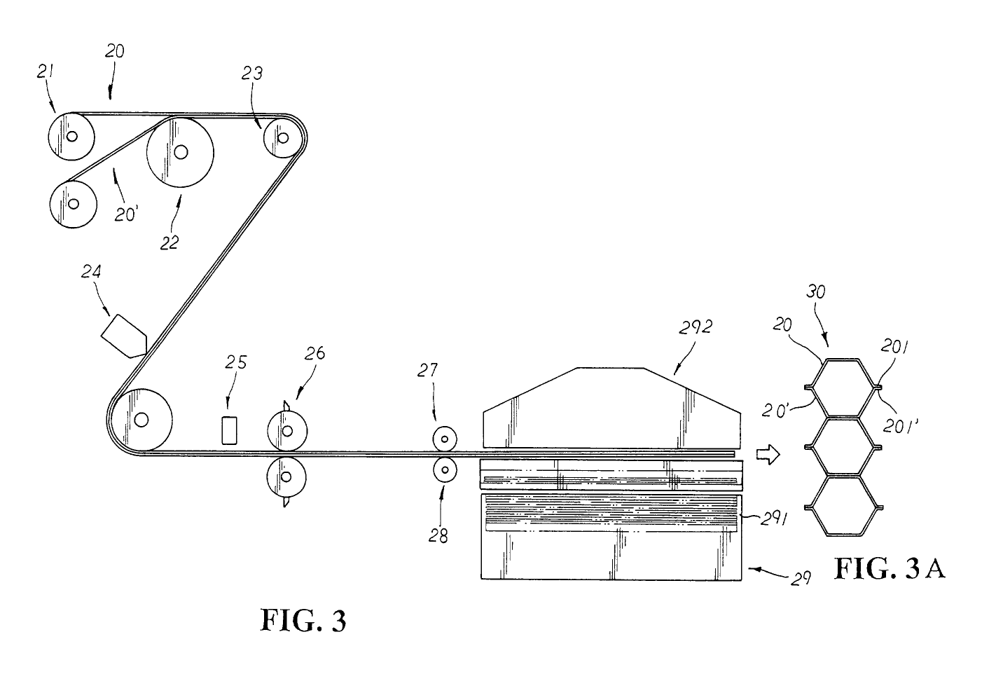

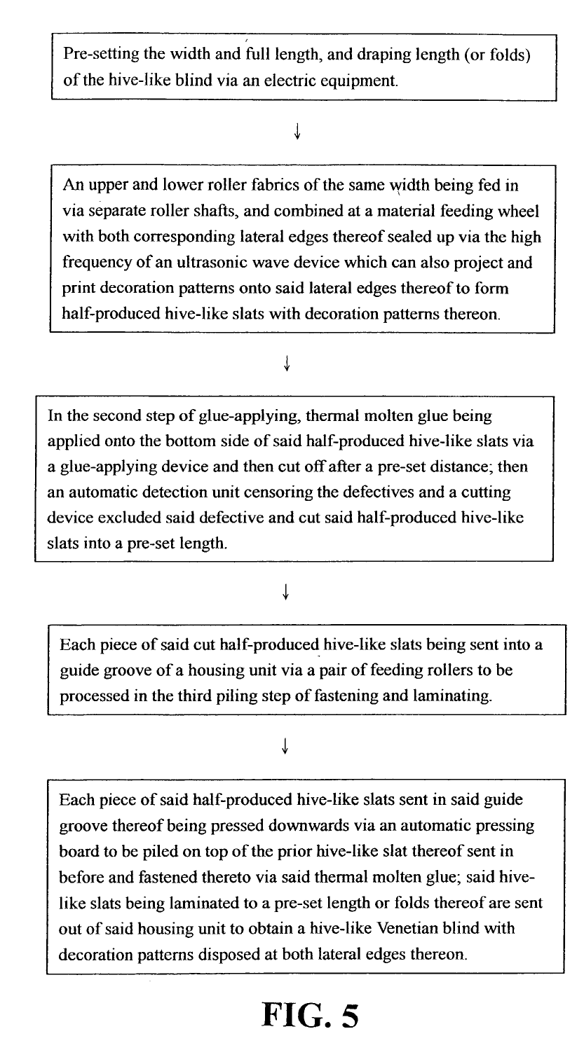

Please refer to FIG. 3 along with FIG. 5 showing a block flow chart of the present invention. The present invention is related to an automatic shaping method for production of hive-like Venetian blinds wherein said hive-like Venetian blind being preset in full length, draping length (or folds thereof) beforehand via an eclectic equipment is produced in operation steps as follows:

First, an upper and lower roller fabrics 20, 20′ of the same width are fed in via two separate roller shafts 21. When motors are turned on to rotate said roller shafts 21, said roller fabrics 20, 20′ will be sent out respectively there-from to meet and combine at a material-feeding wheel 22 with both corresponding lateral edges of said roller fabrics 20, 20′ thereof abutting and layered up thereon. Said material-feeding wheel 22 will send the combined roller fabrics 20, 20′ to the first sealing step of high frequency welding via an ultrasonic wave device 23 which will not only join and seal up said roller fabrics 20, 20′ at both corresponding lateral edges thereof, but also project and print decoration patterns thereon via said ultrasonic wave to form half-produced hive-like slats.

Second, said half-produced hive-like slats made up of roller fabrics 20, 20′ are then moved to the next step of glue-applying wherein a fastening unit 24 with thermal molten glue therein will automatically contact the bottom side of said half-produced hive-like slats thereof to apply said thermal molten glue thereon before breaking the contact there-from after the preset draping length of said hive-like blind thereof. An automatic detection unit 25 will then censor the half-produced hive-like slats with said thermal molten glue 24 applied thereon and pick out the defective ones thereof to be cut off at an cutting device 26 which also serve to cut and divide said half-produced hive-like slats at a pre-set length for further production.

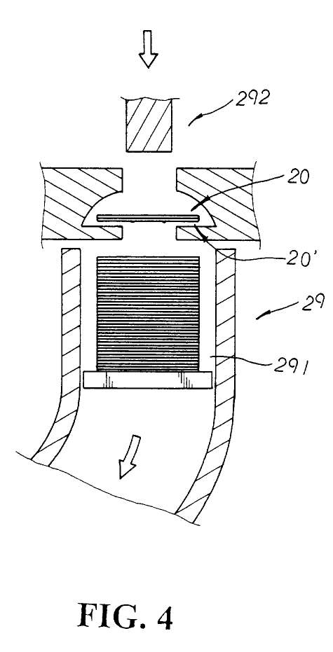

Third, said half-produced hive-like slats cut into a certain length via said cutting device 26 are sent into a guide groove 291 of a housing unit 29 via a pair of feeding rollers 27, 28 to be processed at the third piling step of fastening and laminating. Each piece of said cut hive-like slats sent into said guide groove 291 thereof is pressed downwards via an automatic pressing board 292 to be piled on top of the prior hive-like slat sent in before and stuck thereto via said thermo molten glue thereof to form a hive-like blind structure as shown in FIG. 3-A. After being laminated into a pre-sent draping length or folds thereof, said hive-like slats will be sent out from the bottom side of said housing unit 29 thereof to obtain a hive-like Venetian blind 30 with decoration patterns disposed thereon as shown in FIG. 4.

What is claimed is:

1. An automatic shaping method for producing hive-like Venetian blinds wherein said hive-like Venetian blind being preset in full length, draping length (or folds thereof) beforehand via an eclectic equipment is produced in several steps as follows;
in a first step an upper and lower roller fabrics of the same width being fed in from two separate roller shafts which, rotated via motors, will send out said roller fabrics respectively for them to meet at a material-feeding wheel with both corresponding lateral edges thereof abutting and layered up thereon; said material-feeding wheel sending said combined roller fabrics to the first sealing step of high frequency welding via an ultrasonic wave device which not only joining and sealing up said roller fabrics at both corresponding lateral edges thereof, but also projecting and printing decoration patterns thereon via ultrasonic wave to form half-produced hive-like slats;
in a second step said half-produced hive-like slats made up of said roller fabrics being then moved to the next step of glue-applying wherein a fastening unit with thermal molten glue therein will automatically contact the bottom side of said half-produced hive-like slats thereof to apply said thermal molten glue thereon before breaking the contact there-from after the preset draping length of said hive-like blind thereof; an automatic detection unit then censoring the half-produced hive-like slats with said thermal molten glue applied thereon, picking out the defective ones thereof to be excluded via an cutting device which also serves to cut and divide said half-produced hive-like slats at a pre-set length for further production;
in a third step said half-produced hive-like slats cut into a certain length via said cutting device being sent into a guide groove of a housing unit via a pair of feeding rollers to be processed at the third piling step of fastening and laminating wherein each piece of said cut hive-like slats sent into said guide groove thereof being pressed downwards via an automatic pressing board to be piled on top of the prior hive-like slat sent in before and stuck thereto via said thermal molten glue thereof to form a hive-like blind; after being laminated into the present draping length or folds thereof, said laminated hive-like slats will be slid and sent out from the bottom side of said housing unit thereof to obtain a hive-like Venetian blind with decoration pattern disposed at both lateral edges thereon.
